(19) United States
(12) Patent Application Publication
(10) Pub. No.: US 2026/0103076 A1
(43) Pub. Date: Apr. 16, 2026

(54) STEERING COLUMN SWITCH, STEERING WHEEL SYSTEM, MOTOR VEHICLE, AND METHOD

(71) Applicant: VOLKSWAGEN AKTIENGESELLSCHAFT, Wolfsburg (DE)

(72) Inventors: Thomas Mauterer, Braunschweig (DE); Thomas Fricke, Danndorf (DE)

(21) Appl. No.: 19/114,270

(22) PCT Filed: Aug. 16, 2023
(86) PCT No.: PCT/EP2023/072588

§ 371 Date: Mar. 21, 2025

(30) Foreign Application Priority Data
Oct. 4, 2022 (DE) 102022210464.1

(51) Int. Cl. B60K 35/10; B60K 35/25; B62D 1/04

(52) U.S. Cl. CPC B60K 35/10; B60K 35/25; B60K 2360/131; B60K 2360/1446; B60K 2360/586; B62D 1/04

(57) ABSTRACT

The present disclosure describes a steering column switch for a motor vehicle, such as an electric motor vehicle, designed to select functions. A rigid lever is at least partially surrounded by a lever cap that includes at least one touch sensor. The touch sensor enables function selection through a defined user contact. A monitoring unit, connected to the touch sensor for data transmission, detects the selected function and relays it via an interface to a motor vehicle control device, facilitating execution of an action corresponding to the selected function.

### RELATED APPLICATIONS

The present application claims priority to International Patent Application No. PCT/EP2023/072588 to Mauterer et al., filed Aug. 16, 2023, which claims priority from German Patent App. No. DE 10 2022 210 464.1, filed Oct. 4, 2022, the contents of each being incorporated by reference in their entirety herein.

### TECHNICAL FIELD

The present disclosure relates to a steering column switch for a motor vehicle, a steering wheel system for a motor vehicle a motor vehicle, and to a method for carrying out a function by means of a steering column switch for a motor vehicle, in which a steering column switch can be easily integrated into a control system of a motor vehicle to provide simplified selection of the functions of the steering column switch, while being variably adaptable.

### BACKGROUND

The steering concepts and the designs thereof are changing in new concepts for motor vehicles. For example, steering concepts and consequently also the steering wheels are increasingly integrated in the electrical control system. As a result, the position and the design of both the steering system and of the steering wheels can change. Nonetheless, the customary concepts for making selections are to be available to the driver or operator. It is therefore necessary to adapt the steering column levers for selecting the directional signaling or windshield wiper system and various other functions to the new circumstances.

Steering column switches and steering concepts that can be integrated into the electrical control system are previously known from the prior art. These must usually be actuated mechanically, that is, comprise a slot for actuating switches or rotating parts for selecting functions. Due to their design configuration, such steering column switches can only be adapted with difficulty to novel steering concepts and functions.

### SUMMARY

Aspects of the present disclosure are directed to at least partially overcoming at least one of the above-described disadvantages of the steering system of a motor vehicle. In particular, aspects of the present disclosure are directed to providing a steering column switch for a motor vehicle, a steering wheel system for a motor vehicle, a motor vehicle, and a method for carrying out a function by means of a steering column switch for a motor vehicle, in which a steering column switch can be easily integrated into a control system of a motor vehicle, and the steering column switch for a motor vehicle allows a simple selection of the functions of the steering column switch, while being variably adaptable.

According to some aspects of the present disclosure, the described functionality is achieved by the independent claims of the present application, as detailed below. Additional aspects are disclosed in the dependent claims, the description, and the drawings. Features and details that are described in connection with the steering column switch also apply in connection with the steering wheel system and/or in connection with the motor vehicle, and/or in connection with the method, and vice versa, so that mutual reference is made, or can be made, in each case to the individual aspects of the invention with respect to the disclosure.

In some examples, a steering column switch for a motor vehicle is disclosed, such as an electric motor vehicle, for selecting functions, comprising a rigid lever and a lever cap that at least partly surrounds the lever, wherein the lever cap comprises at least one touch sensor for selecting at least one function by means of a defined touch by an operator, and comprising a control unit which has a data-communicating connection to the touch sensor and which is designed to detect the selected function and to relay the detected function via an interface of the control unit to a control device of the motor vehicle for carrying out an action corresponding to the selected function.

In some examples, a steering wheel system for a motor vehicle is disclosed, comprising a steering wheel, a steering wheel mount, and at least one steering column switch according to any examples provided herein, wherein the lever of the at least one steering column witch is attached to the steering wheel or to the steering wheel mount.

Such configurations are particularly advantageously suited for motor vehicles comprising a steer-by-wire steering system.

The steering wheel system according to the further aspect of the present disclosure thus has the same advantages as those that are also described herein with respect to the steering column switch according to the first aspect of the invention.

In some examples, a motor vehicle is disclosed, such as an electric motor vehicle, comprising a steering wheel system according to any of the examples provided herein.

The motor vehicle according to the further aspect of the present disclosure thus likewise has the same advantages as those that were previously described with respect to the steering column switch according to the first aspect of the invention.

In some examples, a method is disclosed for carrying out a function by means of a steering column switch for a motor vehicle, comprising: defined touching of the at least one touch sensor of the steering column switch by an operator for selecting at least one function; detecting the selected function by the control unit; and relaying the selected function for carrying out an action corresponding to the selected function to a control device of the motor vehicle via the interface of the control unit.

Additional advantages, features and details of the present disclosure will be apparent from the following description, which describes in detail multiple exemplary embodiments of the invention with reference to the drawings. The features described in the claims and in the description can be essential to the present disclosure either alone or in any arbitrary combination.

### BRIEF DESCRIPTION OF THE DRAWINGS

Aspects of the present disclosure will be described hereafter in exemplary embodiments based on the associated drawings. In the drawings:

FIG. 1 shows a schematic representation of a steering column switch for a motor vehicle comprising various touch sensors, according to some aspects of the present disclosure;

FIG. 2 shows a schematic representation of a steering column switch comprising a touch sensor including selection regions, according to some aspects of the present disclosure;

FIG. 3 shows a schematic representation of a steering wheel system, according to some aspects of the present disclosure;

FIG. 4 shows a schematic representation of a motor vehicle, according to some aspects of the present disclosure; and

FIG. 5 shows a method for carrying out a function by means of a steering column switch for a motor vehicle, according to some aspects of the present disclosure.

### DETAILED DESCRIPTION

In various examples described herein, a “defined touch” refers to a touch executed at a specific position or location for a particular duration, with a specific pressure, and/or following a particular sequence of motions. The nature of the defined touch depends on the selected sensor or sensors, and the triggering movement may include tapping, pressing, or rotating about the longitudinal axis of the steering column switch, where the rotation is indicated solely by the user's fingers. The lever cap may be semi-transparent, feature a surface structure, and/or include an LED mat, making the positions of functions tactilely or visually perceptible through haptics or sight, thereby simplifying operation. Forming the lever cap from a plastic material, such as a hard or flexible plastic, may enhance this functionality.

Each position on the steering column switch corresponds to a function activated by the defined touch, and multiple positions may each be associated with a respective function. Functions assigned to or selected via the lever cap may include safety-related operations, such as activating a turn signal or windshield wiper, as well as technical operations, such as engaging cruise control or adjusting a radio setting.

The touch sensor may operate similarly to a push button, delivering pulses to activate a circuit or process; for instance, it may respond solely to pressure, with the pulse triggered based on line resistance. The present disclosure also contemplates setting and selecting one or more intensity levels based on the duration, pressure, and/or number of defined touches. The functions may further depend on the lever cap, which can be designed to be replaceable according to user preferences. To facilitate replacement, the lever and lever cap may be detachably connected, for example, via detent connections, screw connections, or adhesive connections, allowing straightforward swapping of the lever cap.

A data-communicating connection between the touch sensor and the control unit transmits information indicating which position is currently subjected to a defined touch and for how long, enabling the control unit to identify the function to be executed. This connection may employ a cable or a wireless method, such as radio transmission. The steering column switch described herein can feature a straightforward design; without dimensional constraints imposed by mechanical components, its positioning is no longer restricted by the steering column, allowing placement independent of it. Additionally, the steering column switch can be tailored to a user, with user-specific replacement of the lever cap being feasible.

In certain embodiments of the present disclosure, the at least one touch sensor may comprise a capacitive and/or resistive touch sensor. The touch sensor or sensors may be applied to the inner side and/or outer side of the lever cap or integrated into the lever cap material, enabling adaptability to specific circumstances and available sensors. For a capacitive touch sensor, a film may be utilized, covering the entire surface of the lever cap or applied only at specific positions; alternatively, individual sensors may be positioned between the lever cap and the lever, with their locations selected independently. This flexibility allows sensor positions to be customized for each user, ensuring ease of operation, and the present disclosure also allows for retrofitting an existing system with a lever cap incorporating a capacitive and/or resistive touch sensor.

According to some embodiments, at least one strain gauge may be included to detect the defined touch. Positioning the at least one strain gauge along the longitudinal extension of the steering column switch can be particularly beneficial; to detect the strength or intensity of a touch at any point along the longitudinal axis, providing at least one strain gauge especially one with a cross geometry-is advantageous. The control unit can detect and measure resistance changes when the at least one strain gauge is touched, recognizing the intensity and duration of a touch along the axial direction. Using the at least one strain gauge, a function can be configured to activate only when a specific force threshold is met.

In some embodiments, a vibration motor may be incorporated in and/or on the lever to provide haptic feedback for the selected function. The vibration motor is configured to deliver haptic feedback, with different vibration intensities achievable through varying frequencies or rhythms; for example, the vibration may mimic the feel of a detent mechanism, providing the operator with haptic feedback comparable to that of a mechanical steering column switch.

In certain implementations, the control unit may be configured to detect a selected function when a predetermined touch duration and/or pressure of the defined touch is exceeded, ensuring that only predefined touches trigger a function and preventing unintended activations. Both touch duration and pressure can be adjusted to suit the operator's preferences; for instance, the touch duration may range from 1 to 5 seconds, preferably between 1.5 and 4 seconds. User-specific settings can be stored in the control unit and programmed via an interface and a human-machine interface.

The position of the at least one touch sensor may be adjustable via the control unit; alternatively, the touch sensor may include multiple selection regions, with functions assigned to these regions through the control unit. This adaptability allows users to freely select sensor positions according to their needs; for example, touch sensors may be pre-installed in or on the lever cap, with their assignments configured via the control unit, and if the touch sensor includes selection regions, these can be defined and associated with specific functions. User-specific data, such as sensor assignments, can be stored in the control unit and programmed using an interface and a human-machine interface.

Optionally, the control unit may include an interface to relay the selected function to a motor vehicle control system and/or a human-machine interface, facilitating the transmission of data for executing the selected function(s) and enabling assignment of touch sensors to specific functions via the human-machine interface.

As used herein, a “defined touch” refers to a touch executed at a specific position or location for a particular duration, with a specific pressure, and/or following a particular sequence of motions; the nature of the defined touch depends on the selected sensor or sensors, and the triggering movement may include tapping, pressing, or rotating about the longitudinal axis of the steering column switch, indicated solely by the user's fingers. Each position corresponds to a function activated by the defined touch, and multiple positions on the steering column switch may each be associated with a respective function. Functions assigned to or selected via the lever cap may include safety-related operations, such as activating a turn signal or windshield wiper, as well as technical operations, such as engaging cruise control or adjusting a radio setting. The advantages described above with respect to the steering column switch also apply to the method outlined in additional aspects of the present disclosure.

In some embodiments, the defined touch may be detected using a capacitive and/or resistive touch sensor. The touch sensor or sensors may be applied to the inner side and/or outer side of the lever cap or integrated into the lever cap material, enabling adaptation to specific circumstances and available sensors. For a capacitive touch sensor, a film may be utilized, covering the entire surface of the lever cap or applied only at specific positions; alternatively, individual sensors may be positioned between the lever cap and the lever, with their locations selected independently, allowing sensor positions to be tailored to the user for ease of operation.

In certain embodiments, the defined touch may be detected using at least one strain gauge. Positioning the at least one strain gauge along the longitudinal extension of the steering column switch is particularly advantageous; to detect touch strength or intensity at any point along the longitudinal axis, providing at least one strain gauge-especially one with a cross geometry-is beneficial. The control unit can detect and measure resistance changes when the at least one strain gauge is touched, recognizing the intensity and duration of a touch along the axial direction, and a function can be configured to activate only when a specific force threshold is met.

In some implementations, feedback for the defined touch may be provided via vibration from the vibration motor, which is configured to deliver haptic feedback. The vibration motor may offer varying intensities through different frequencies or rhythms; for example, the vibration may simulate a detent mechanism, providing haptic feedback akin to that of a mechanical steering column switch.

In certain embodiments, the control unit may detect a selected function when a predetermined touch duration and/or pressure of the defined touch is exceeded, ensuring that only predefined touches trigger a function and avoiding unintended activations. Both touch duration and pressure can be tailored to the operator's needs, with touch duration ranging, for example, from 1 to 5 seconds, preferably 1.5 to 4 seconds, and user-specific settings can be stored in the control unit and programmed via an interface and a human-machine interface.

The position of the at least one touch sensor may be adjustable via the control unit; alternatively, the touch sensor may include multiple selection regions, with functions assigned to these regions through the control unit. This configuration enables straightforward execution of selected functions and allows assignment of touch sensors to specific functions via the interface and human-machine interface.

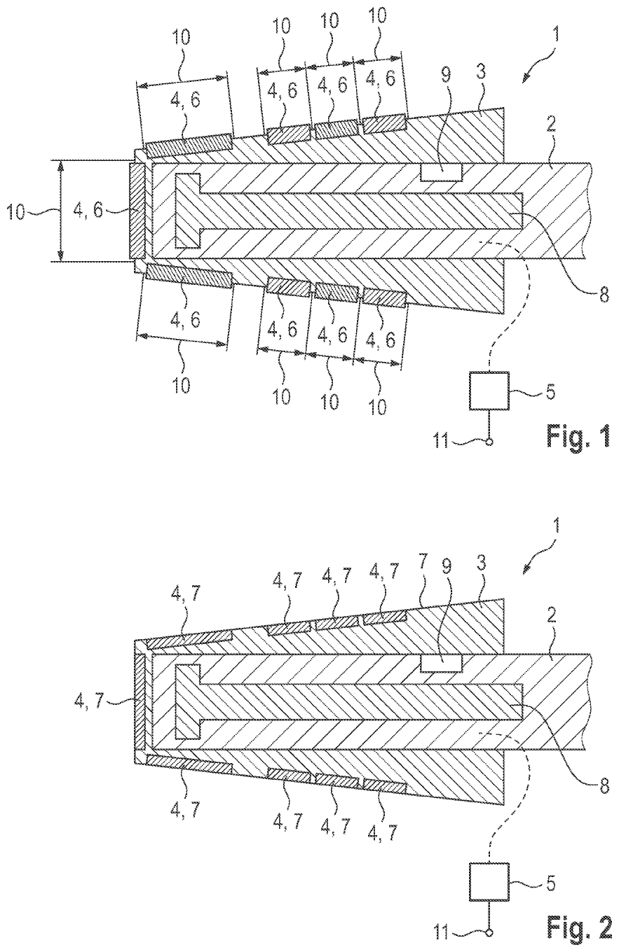

FIGS. 1 and 2 each show a steering column switch 1 for a motor vehicle, in particular an electric motor vehicle, for selecting functions. The steering column switch 1 features a rigid lever 2 and a lever cap 3 that at least partly surrounds the lever 2. The lever cap 3 includes at least one touch sensor 4 for selecting at least one function through a defined touch by an operator. Furthermore, a control unit 5 that has a data-communicating connection to the touch sensor 4 is provided, which is designed to detect the selected function and relay the detected function via an interface 11 of the control unit 5 to a control device of the motor vehicle for carrying out an action corresponding to the selected function.

The touch sensor 4, or the plurality of touch sensors 4, are resistive touch sensors 6 in FIG. 1 that respond to an actuation by means of pressure. The touch sensor 4 in FIG. 2 is a capacitive touch sensor 7, the surface of which is distributed around the entire lever cap 3 and has various selected regions with which functions are associated.

To more accurately detect a defined touch, the two steering column switches 1 include a strain gauge 8. The strain gauge extends in the longitudinal direction of the steering column switch 1. A strain gauge 8 with a cross geometry is installed to detect movements of the steering column switch 1 in the horizontal or transverse direction.

The functions set by the steering column switch 1 can be selected in varying intensities. For example, the turn signal may only flash a few times for a defined touch that is light or brief, such as for a duration of 1.2 seconds, or it may continuously flash during a turning process for a defined touch that involves higher pressure or a longer duration, such as a touch of 3 seconds. To select the correct intensity level of the chosen function, haptic feedback from a vibration motor 9 in the lever 2 is provided.

The control unit 5 of the steering column switches according to FIG. 1 and FIG. 2 is designed to detect a selected function as soon as a determinable touch duration of the defined touch is exceeded and/or as soon as a determinable touch pressure of the defined touch is exceeded.

The resistive touch sensors 6 shown in FIG. 1 are already provided; however, it is not necessary for all these touch sensors 4 to have a stored function. Rather, the operator can adapt the assignment of the resistive touch sensors 6 to the desired function according to his or her needs. This is to be carried out by means of the control unit 5.

The steering column switch 1 of FIG. 2 comprises a capacitive touch sensor 7. This sensor is characterized in that, in principle, the entire surface can be used as a sensor. However, it is useful for the sensor, as shown, to have multiple selection regions 10, with functions associated with the selection regions 10 via the control unit 5.

To simplify programming, that is, the association and adaptation of the positions of the selection regions 10 or the assignment of the touch sensors 4, the control unit 5 comprises an interface 11 for relaying the functions to be carried out to a motor vehicle control system and/or a human-machine interface.

The steering column switch 1 according to FIG. 1 and FIG. 2 is suitable for use in a steer-by-wire steering wheel system comprising a steering wheel, a steering wheel mount, and a steering column switch. The lever 2 of the at least one steering column switch 1 is attached to the steering wheel or to the steering wheel mount.

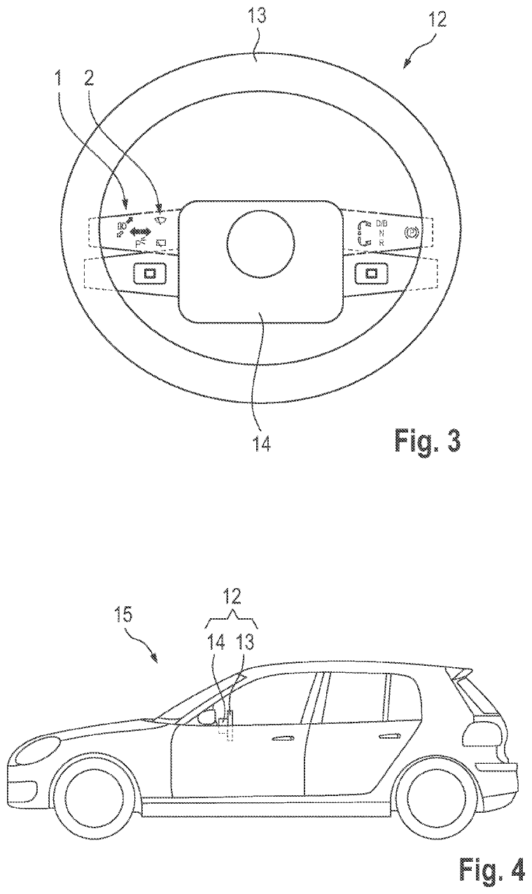

FIG. 3 schematically shows a steering wheel system 12 for a motor vehicle 15 comprising a steering wheel 13, a steering wheel mount 14, and at least one steering column switch 1, as described above. The lever 2 of the at least one steering column switch 1 is attached to the steering wheel 13 or to the steering wheel mount 14.

FIG. 4 shows a motor vehicle 15, in particular an electric motor vehicle 15, comprising a steering wheel system 12. The steering wheel system 12 comprises at least one of the above-described steering column switches of FIGS. 1 to 2.

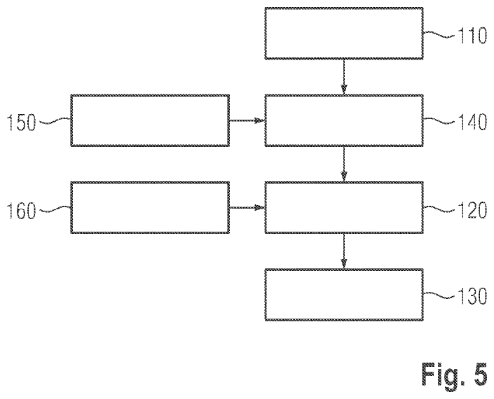

FIG. 5 shows an exemplary method 100 for carrying out a function by means of a steering column switch 1 according to either FIG. 1 or 2. The method 100 comprises the following steps: defined touching 110 of the at least one touch sensor 4 of the steering column switch 1 by an operator for selecting at least one function; detecting 120 the selected function by the control unit 5; and relaying 130 the selected function for carrying out an action corresponding to the selected function to a control device of the motor vehicle via the interface 11 of the control unit 5.

So as to carry out the defined touch 110 more precisely, the functions are associated with the user-defined positions in a preceding step for the steering column switch 1 according to FIG. 1 via the control unit 5, whereby the assignment of the touch sensors 4 is adapted 140. In FIG. 2, the functions are associated 150 with the desired selection regions 10 of the touch sensor 4.

The defined touch in FIG. 1 is detected by means of a capacitive touch sensor 4, and in FIG. 2 it is detected by means of a resistive touch sensor 4, in each case in combination with a strain gauge 8 having a cross geometry.

In the case of a defined touch, feedback regarding the defined touch is provided by means of a vibration from the vibration motor 9. The feedback can convey 160 various intensity levels and can have differing vibration strengths and/or rhythms for this purpose.

Furthermore, a selected function is detected 120 as soon as a determinable touch duration (FIG. 2) of the defined touch is exceeded and/or as soon as a determinable touch pressure (FIG. 1) of the defined touch is exceeded.

### LIST OF REFERENCE NUMERALS

1 steering column switch

2 lever

3 lever cap

4 touch sensor

5 control unit

6 resistive touch sensors

7 capacitive touch sensor

8 strain gauge, strain gauge having a cross geometry

9 vibration motor

10 selection regions

11 interface

12 steering wheel system

13 steering wheel

14 steering wheel mount

15 motor vehicle

100 method

110 defined touching

120 detecting

130 relaying

140 adapting

150 associating

160 feeding back

1-15. (canceled)

16. A steering column switch for a motor vehicle configured to select functions, comprising:
a rigid lever;
a lever cap at least partially surrounding the rigid lever, the lever cap including at least one touch sensor configured to select at least one function through a defined touch by an operator; and
a control unit having a data-communicating connection to the at least one touch sensor, the control unit configured to detect the selected function and relay the detected function via an interface of the control unit to a control device of the motor vehicle to execute an action corresponding to the selected function.

17. The steering column switch of claim 16, wherein the at least one touch sensor includes a capacitive touch sensor or a resistive touch sensor.

18. The steering column switch of claim 16, further comprising at least one strain gauge configured to detect the defined touch.

19. The steering column switch of claim 16, further comprising a vibration motor disposed in or on the rigid lever, the vibration motor configured to provide haptic feedback corresponding to the selected function.

20. The steering column switch of claim 16, wherein the control unit is configured to detect the selected function when a predetermined touch duration of the defined touch is exceeded or a predetermined touch pressure of the defined touch is exceeded.

21. The steering column switch of claim 16, wherein a position of the at least one touch sensor is adjustable via the control unit; or the at least one touch sensor includes a plurality of selection regions, and the control unit is configured to associate functions with the plurality of selection regions.

22. The steering column switch of claim 16, wherein the interface of the control unit is configured to relay the selected function to a motor vehicle control system or a human-machine interface.

23. A steering wheel system for a motor vehicle, comprising:
a steering wheel;
a steering wheel mount; and
at least one steering column switch including:
a rigid lever attached to the steering wheel or the steering wheel mount;
a lever cap at least partially surrounding the rigid lever, the lever cap including at least one touch sensor configured to select at least one function through a defined touch by an operator; and
a control unit having a data-communicating connection to the at least one touch sensor, the control unit configured to detect the selected function and relay the detected function via an interface of the control unit to a control device of the motor vehicle to execute an action corresponding to the selected function.

24. The steering wheel system of claim 23, wherein the at least one touch sensor of the at least one steering column switch includes a capacitive touch sensor or a resistive touch sensor.

25. The steering wheel system of claim 23, wherein the at least one steering column switch further includes at least one strain gauge configured to detect the defined touch.

26. The steering wheel system of claim 23, wherein the at least one steering column switch further includes a vibration motor disposed in or on the rigid lever, the vibration motor configured to provide haptic feedback corresponding to the selected function.

27. The steering wheel system of claim 23, wherein the control unit of the at least one steering column switch is configured to detect the selected function when a predetermined touch duration of the defined touch is exceeded or a predetermined touch pressure of the defined touch is exceeded.

28. The steering wheel system of claim 23, wherein a position of the at least one touch sensor of the at least one steering column switch is adjustable via the control unit; or the at least one touch sensor includes a plurality of selection regions, and the control unit is configured to associate functions with the plurality of selection regions.

29. The steering wheel system of claim 23, wherein the interface of the control unit of the at least one steering column switch is configured to relay the selected function to a motor vehicle control system or a human-machine interface.

30. A method for executing a function using a steering column switch of a motor vehicle, the steering column switch comprising a rigid lever, a lever cap at least partially surrounding the rigid lever and having at least one touch sensor, and a control unit having a data-communicating connection to the at least one touch sensor, the method comprising:
receiving a defined touch on the at least one touch sensor by an operator to select at least one function;
detecting, by the control unit, the selected function based on the defined touch; and
relaying, via an interface of the control unit, the selected function to a control device of the motor vehicle to execute an action corresponding to the selected function.

31. The method of claim 30, wherein detecting the defined touch comprises using a capacitive touch sensor or a resistive touch sensor of the steering column switch.

32. The method of claim 30, wherein detecting the defined touch comprises using at least one strain gauge of the steering column switch.

33. The method of claim 30, further comprising providing haptic feedback for the defined touch via a vibration motor of the steering column switch, wherein the vibration motor generates a vibration corresponding to the selected function.

34. The method of claim 30, wherein detecting the selected function comprises determining that a predetermined touch duration of the defined touch is exceeded or a predetermined touch pressure of the defined touch is exceeded.

35. The method of claim 30, further comprising adapting a position of the at least one touch sensor via the control unit; or associating functions with a plurality of selection regions of the at least one touch sensor via the control unit.
